(19) United States
(12) Patent Application Publication
(10) Pub. No.: US 2006/0142679 A1
(43) Pub. Date: Jun. 29, 2006

(54) Backscratcher for relieving itches

(76) Inventor: Fu-Hsing Tan, Dongguan (CN)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/188,950

(22) Filed: Jul. 25, 2005

(30) Foreign Application Priority Data
Dec. 25, 2004 (CN) 200420103442.0

(51) Int. Cl. A61H 7/00

(52) U.S. Cl. 601/137; 601/135

(57) ABSTRACT

A backscratcher for relieving itches includes a head portion having a claw element in an end thereof; and a handle portion; wherein the handle portion is active connected with the head portion in the other end thereof. The backscratcher as claimed in claim 1, wherein the handle portion is hinged with the head portion. The backscratcher further includes a receptacle for receiving the handle portion, the handle portion is slidable in the receptacle.

### FIELD OF THE INVENTION

The present invention relates to a backscratcher, and more particularly relates to a backscratcher with a foldable and telescopic handle portion.

### BACKGROUND OF THE INVENTION

In usual life, a physical tool commonly called a backscratcher is used to relieve itches generated from hard-to-reach areas of the person body. A conventional backscratcher 1 shown in FIG. 5 has an integral structure which comprises a handle portion and a claw portion extending from the handle portion. For effectively scratching and relieving itches, the backscratcher 1 must have a long length. However, this will increase the volume of the backscratcher so that the backscratcher 1 is difficult to be stored, taken or transported.

### SUMMARY OF THE INVENTION

A main feature of the present invention is to provide a backscratcher which has a collapsible handle portion.

Another feature of the present invention is to provide a backscratcher the length of which is changeable according to individual need.

According to one embodiment of the invention, a backscratcher for relieving itches comprises a head portion having a claw element in an end thereof; and a handle portion; wherein the handle portion is active connected with the head portion in the other end thereof. The handle portion is hinged with the head portion.

In an embodiment, a resilient piece is attached to the inner wall of the claw element of the head portion. Said head portion has a pair of pivoting blocks at one end adjacent the handle portion, each of pivoting block having a central hole; said handle portion has a tubular portion with a central hole defined therein at one end adjacent the head portion for being disposed between the two pivoting blocks; and a lock element is provided to extend through the central holes of the pivoting blocks and the tubular portion to hinge the head portion with the handle portion. In the invention, the lock element may be a pin or a spindle element. In an embodiment, the spindle element is an elastic element having a central opening formed therein. Said head portion further comprises an engage portion having a cavity defined therein; said tubular portion has a protrusion corresponding to the cavity of the engage portion.

In the invention, the backscratcher further comprises a receptacle for receiving the handle portion, the handle portion is slidable in the receptacle. Two railes are formed at both lateral sides of the handle portion in a longitudinal direction; the receptacle has two extrusions provided in its inner side, said extrusions being engaged with the railes of the handle portion; a pair of stopping tabs are respectively formed at the rails at the end of the handle portion adjacent the receptacle; and two notches are respectively formed on the protrusions of the receptacle to engage with the two stopping tabs. A rectangular pad is formed upon the top surface of the handle portion in an end thereof adjacent to the head portion, a containing room is formed in one end of the receptacle for receiving said rectangular pad. The receptacle includes a racket-shaped opening formed at one end adjacent the head portion and a spring element extending upwardly from a bottom inner surface of the receptacle into the racket-shaped opening; the handle portion has a plurality of slots formed along a longitude direction of the handle portion; a switch button is provided to engage with the racket-shaped opening of the receptacle; wherein the switch button has a protruding block, to selectively engage with the slots in the handle portion. The switch button comprises a pressing button and a neck portion connected to the pressing button, the protruding block is formed on said neck portion.

For the purpose of making the invention easier to understand, several particular embodiments thereof will now be described with reference to the appended drawings in which:

### DESCRIPTION OF THE DRAWINGS

FIG. 1 is an exploded, perspective view of the backscratcher according to one embodiment of the invention;

FIG. 2 is a perspective view of the backscratcher FIG. 1, in which the handle portion is extended to it's largest length;

FIG. 3 is a perspective view of the backscratcher FIG. 1, in which the handle portion is retracted within the encasing body;

FIG. 4 is a perspective view of the backscratcher FIG. 1, in which the handle portion is folded against the head portion, thus the volume of the backscratcher is reduced greatly;

FIG. 5 is a perspective view of a conventional backscratcher;

FIG. 6 is an exploded, perspective view of the backscratcher according to another embodiment of the invention;

FIG. 7 is a perspective view of the backscratcher of FIG. 6, in which the handle portion is extended to it's largest length;

FIG. 8 is a bottom elevational view of the backscratcher FIG. 6, in which the handle portion is retracted within an encasing body and achieving it's minimal length;

FIG. 9 is a perspective view of the backscratcher FIG. 6 but viewed in a different direction, in which the handle portion is folded against the head portion, thus the volume of the backscratcher is reduced greatly.

### DETAILED DESCRIPTION OF THE INVENTION

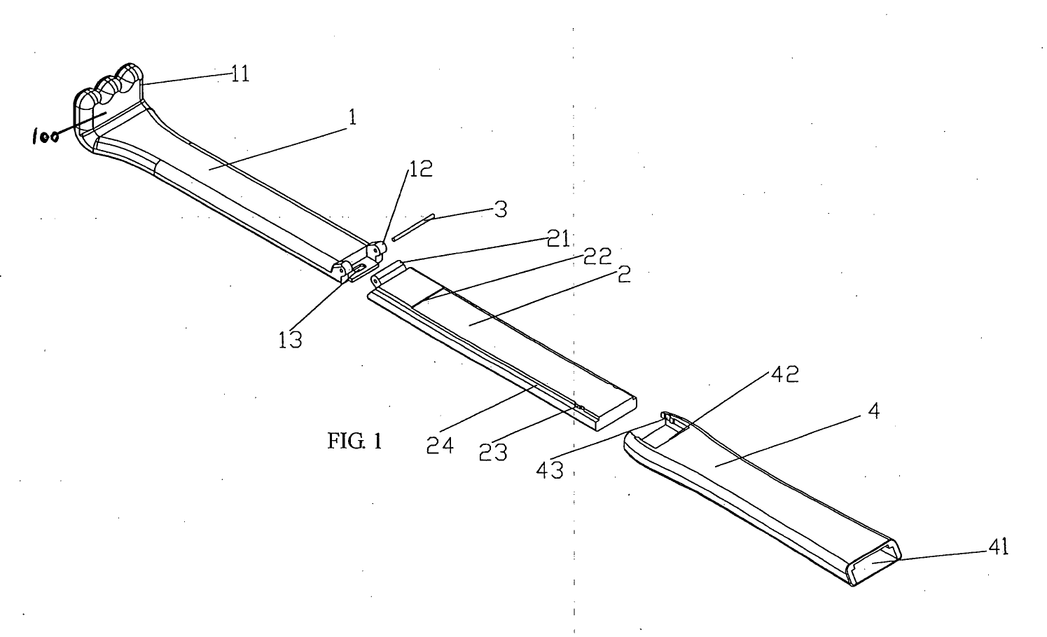

Referring to FIG. 1-4, according to one embodiment of the invention, a backscratcher comprises a head portion 1 with a claw element 11, a handle portion 2 pivotablly secured to said head portion 1 via a thin pin 3 at one end, and an receptacle 4 into which the handle portion 2 can be slidablly secured. A resilient piece 100 is attached to the inner wall of the claw element 11 of the head portion 1 for touching skin of a person, preventing skin injury from hard portion of the backscratcher due to unexpected force.

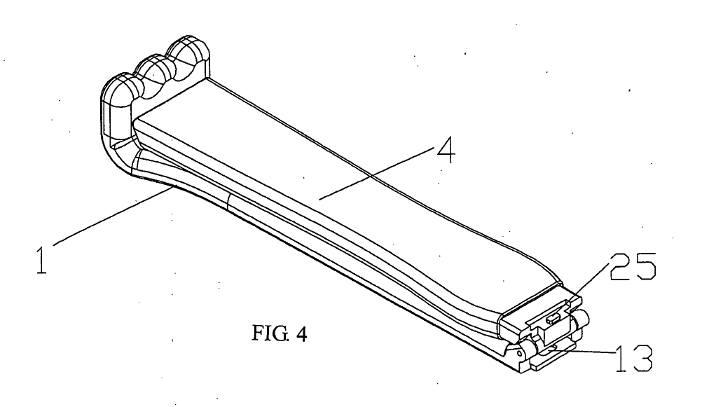

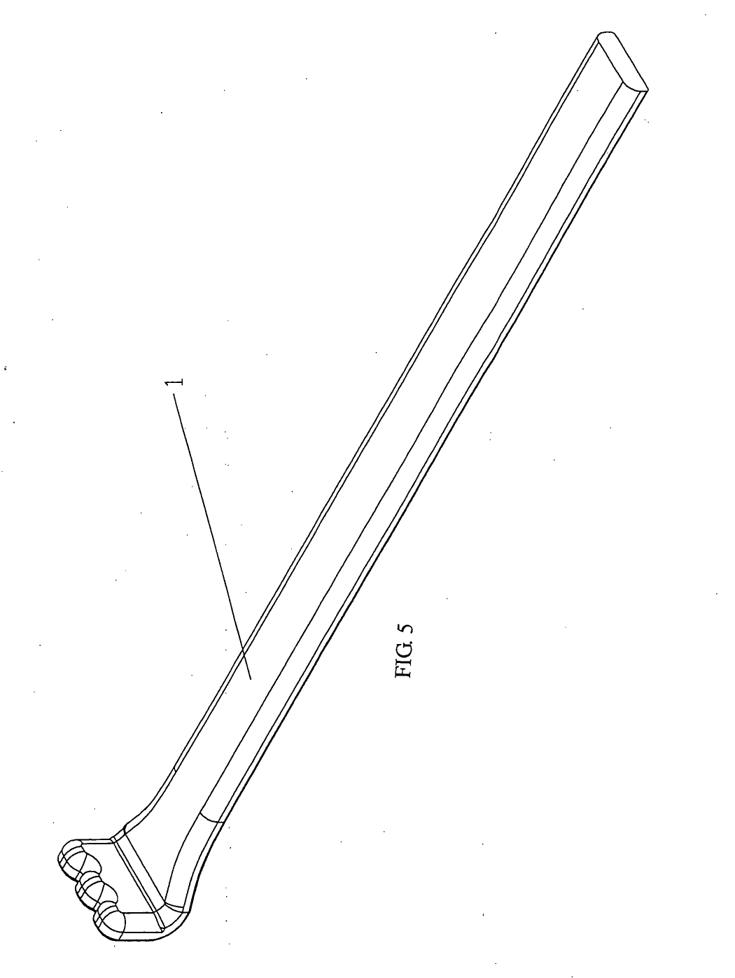

Two pivoting blocks 12 are formed at lateral sides of one end portion of the head portion 1, each having a central hole defined therein respectively. Said end portion is adjacent to the handle portion 2 and each pivoting block 12 is higher than horizontal surface of main body of the head portion 1. A narrow slot 13 is defined on the head portion 1 at position between two pivoting blocks 12. A tubular portion 21 with a central hole (not labelled) defined therein and engagable with the pivoting blocks 12 of the head portion 1 is extended upon one end of the handle portion 2 adjacent the head portion 1, the tubular portion 21 is higher than horizontal surface of main body of the handle portion 2. A protrusion 25 (best shown in FIG. 4) is provided corresponding to the slot 13 of the head portion 1 and which can be received into the slot 13 completely is extended downwardly from the bottom side of the tubular portion 21. The head portion 1 and handle portion 2 are hinged together by inserting the pin 3 into the central holes of the pivoting blocks 12 and tubular portion 21. When in use, there forms an angle of 180 degree between the head portion 1 and the handle portion 2, and the protrusion 25 of the handle portion 2 is contained in the slot 13, thus preventing the handle portion 2 from rotating about the pin 3 when in use.

Two railes 24 are formed at both lateral sides of the handle portion 2 in a longitudinal direction by removing portion material of the handle portion 2. The receptacle 4 has a cavity 41 defined along it's longitudinal length. Corresponding to the railes 24 of the handle portion 2, the cavity 41 has two extrusions (not labeled) in it's both inner sidewalls, by engagement of the railes 24 with the extrusions, the handle portion 2 can get a stable sliding movement against the receptacle 4. A rectangular pad 22 with a suitable thickness is formed upon the top surface of one end of the handle portion 2 near to the head portion 1, and correspondingly, a containing room 42 is formed at one end of the receptacle 4 adjacent the handle portion 2. When the handle portion 2 slides within the cavity 41 toward the receptacle 4, the rectangular pad 22 approaches the containing room 42 and finally is received into the containing room 42, thus preventing further movement of the handle portion 2 toward the receptacle 4. For preventing the handle portion 2 disengaged from the receptacle 4, a pair of stopping tabs 23 formed at respective rail 24 at the other end of the handle portion 2 adjacent the receptacle 4 are locked into respective notches 43, which is formed on both inner sidewalls of the containing room 42 of the receptacle 4. Such sliding structure of the handle portion 2 and the receptacle 4 makes an important contribution to volume reduction of the backscratcher when in storage and enough length when in use.

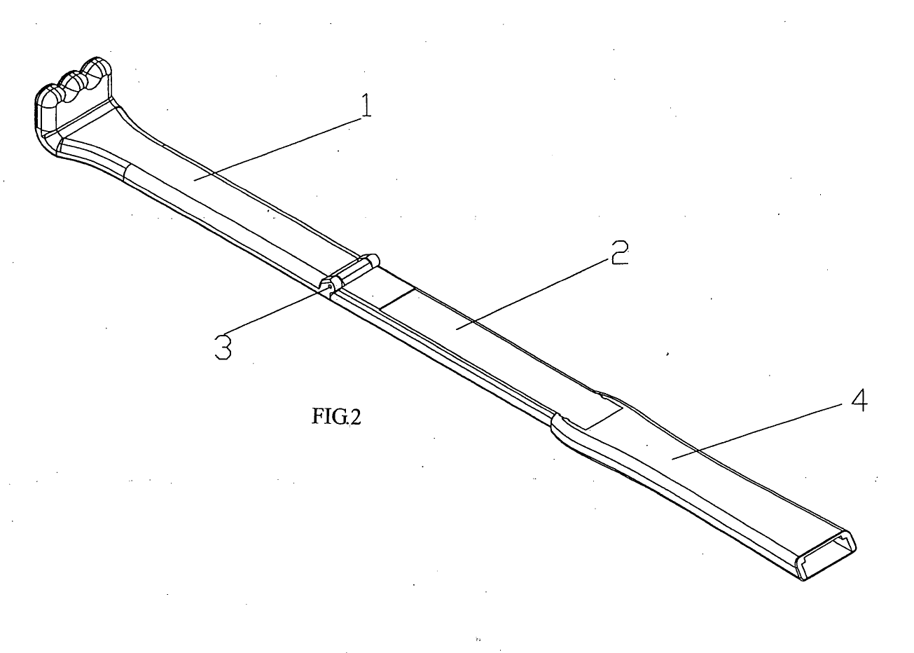

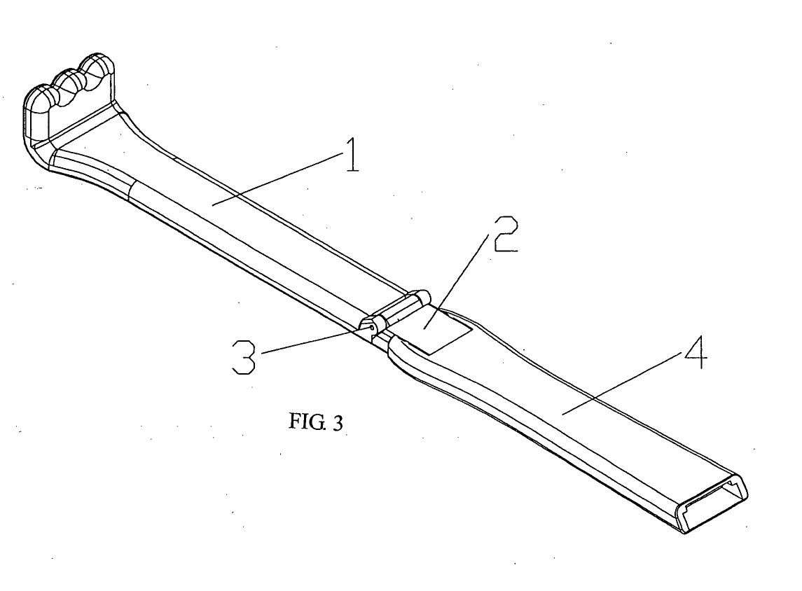

When in use, the backscratcher may get it's maximal length as shown in FIG. 2 and illustrated above; when in storage, the backscratcher may be retracted and folded as shown in sequential FIG. 3 and FIG. 4.

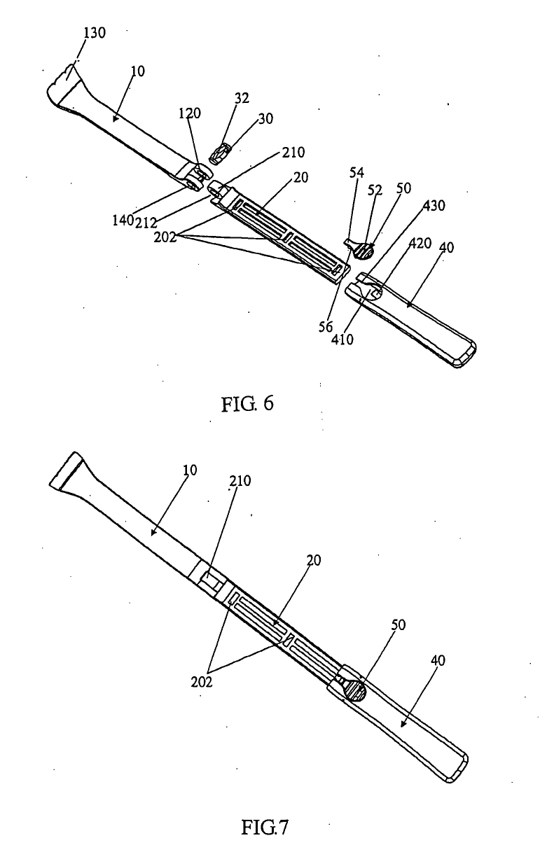

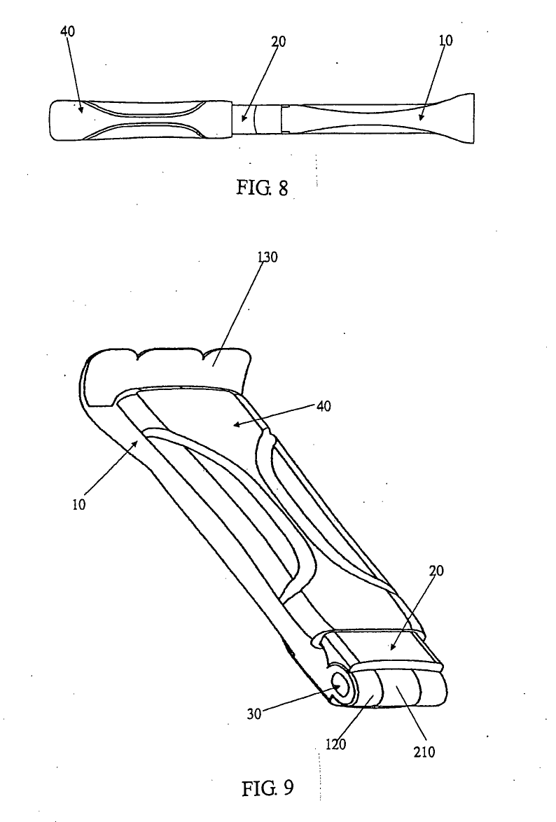

Now referring to FIG. 6-9, another embodiment of the invention will be described. In this embodiment, a backscratcher comprises a head portion 10 with a claw element 130 for scratching the skin of a person formed at one end and two pivoting blocks 120 parallel to each other formed at the other end thereof. The pivoting block 120 is provided with a central hole 140, a handle portion 20 hinged to the head portion 10 by a spindle element 30 and an receptacle 40 connected to the handle portion 20 by a switch button 50. The handle portion 20 has a tubular portion 210 corresponding to the pivoting block 120 of the head portion 10 with a central hole 212 formed therein through the whole length of the tubular portion and a plurality of slot 202 defined along the length of the handle portion 20. The receptacle 40 has a cavity 410 along it's longitudinal direction and a racket-shaped opening 430 formed at one end of thereof adjacent the handle portion 20, the opening 430 communicates the cavity 410. A spring element 420 stretches from a bottom inner surface of the receptcle 4 and extends upwardly into the opening 430. The switch button 50 is shaped corresponding to the opening 430 of the receptacle 40, and comprises a pressing button 52 and a neck portion 54 connected to the pressing button 52. The neck portion 54 has a protruding block 56 extended from the back side of the neck portion 54.

The spindle element 30 has a hole 32 formed on a central portion thereof. The handle portion 20 is hinged with the head portion 10 as follows: disposing the tubular portion 210 between two pivoting blocks 120 firstly making the central holes 140, 212 being aligned each other, then inserting the spindle element 30 into the central holes 140, 212. In this inserting process, the hole 32 is compressed, and when the spindle element 30 is fully positioned, the hole 32 tries to come back to it's original shape and thus produces an outward force against the inner walls of the central holes 140, 212, thus making the spindle element 30 firmly retained in the central holes.

The handle portion 20 is encased in the cavity 410 of the receptacle 40 and can slide along the cavity 410. The switch button 50 is placed into the opening 430 of the receptacle 40 and presses the spring element. 420 downwardly, the protruding block 56 is inserted into one of the slots 202 of the handle portion 20.

When in use, the handle portion 20 and the head portion 10 form a 180 degree. The length of the backscratcher may be changed according to individual need by selectively engaging the switch button 50 with one of the slot 202 of the handle portion 20. Namely, it is performed by pressing the pressing button 52 of the switch button 50 downwardly first, thereby resulting in the protruding block 56 disengaged from one of the slot 202, then drawing the handle portion 20 back or forth from the receptacle 40 for a distance, making another slot 202 positioned under the protruding block 56, finally releasing the switch button 50 and thus the protruding block 56 being locked into the slot 202.

When not in use, the handle portion 20 may be fully inserted into the cavity 410 of the receptacle 40, and then be folded toward the head portion 10 and finally overlaps with the head portion 10. In this case, the volume of the backscratcher is reduced greatly and adapted to be stored.

It is understood that the invention may be embodied in other forms without departing from the spirit thereof Thus, the present examples and embodiments are to be considered in all respects as illustrative and not restrictive, and the invention is not to be limited to the details given herein.

What is claimed is:

1. A backscratcher for relieving itches comprising:
a head portion having a claw element in an end thereof; and
a handle portion; wherein the handle portion is active connected with the head portion in the other end thereof.

2. The backscratcher as claimed in claim 1, wherein the handle portion is hinged with the head portion.

3. The backscratcher as claimed in claim 1, wherein a resilient and soft piece is attached to the inner wall of the claw element of the head portion.

4. The backscratcher as claimed in claim 1, wherein said head portion has a pair of pivoting blocks at one end adjacent the handle portion, each of pivoting block having a central hole; said handle portion has a tubular portion with a central hole defined therein at one end adjacent the head portion for being disposed between the two pivoting blocks; and a lock element is provided to extend through the central holes of the pivoting blocks and the tubular portion to hinge the head portion with the handle portion.

5. The backscratcher as claimed in claim 4, wherein the lock element is a pin or a spindle element.

6. The backscratcher as claimed in claim 5, wherein the spindle element is an elastic element having a central opening formed therein.

7. The backscratcher as claimed in claim 4, wherein said head portion further comprises an engage portion having a cavity defined therein; said tubular portion has a protrusion corresponding to the cavity of the engage portion.

8. The backscratcher as claimed in claim 1, further comprising a receptacle for receiving the handle portion, the handle portion is slidable in the receptacle.

9. The backscratcher as claimed in claim 8, wherein two railes are formed at both lateral sides of the handle portion in a longitudinal direction; the receptacle has two extrusions provided in its inner side, said extrusions being engaged with the railes of the handle portion; a pair of stopping tabs are respectively formed at the rails at the end of the handle portion adjacent the receptacle; and two notches are respectively formed on the protrusions of the receptacle to engage with the two stopping tabs.

10. The backscratcher as claimed in claim 9, wherein a rectangular pad is formed upon the top surface of the handle portion in an end thereof adjacent to the head portion, a containing room is formed in one end of the receptacle for receiving said rectangular pad.

11. The backscratcher as claimed in claim 8, wherein the receptacle includes a racket-shaped opening formed at one end adjacent the head portion and a spring element extending upwardly from a bottom inner surface of the receptacle into the racket-shaped opening; the handle portion has a plurality of slots formed along a longitude direction of the handle portion; a switch button is provided to engage with the racket-shaped opening of the receptacle; wherein the switch button has a protruding block, to selectively engage with the slots in the handle portion.

12. The backscratcher as claimed in claim 11, wherein the switch button comprises a pressing button and a neck portion connected to the pressing button, the protruding block is formed on said neck portion.
